(19) United States
(12) Patent Application Publication
(10) Pub. No.: US 2021/0162661 A1
(43) Pub. Date: Jun. 3, 2021

(54) THREE-DIMENSIONAL PRINTING APPARATUS

(71) Applicant: KLABS INC., Ulsan (KR)

(72) Inventor: Won Hyo KIM, Ulsan (KR)

(21) Appl. No.: 16/804,312

(22) Filed: Feb. 28, 2020

(30) Foreign Application Priority Data
Dec. 2, 2019 (KR) 10-2019-0158275

(51) Int. Cl. B29C 64/209; B29C 64/227; B29C 64/25

(52) U.S. Cl. CPC B29C 64/209; B33Y 30/00; B29C 64/25; B29C 64/227

(57) ABSTRACT

A three-dimensional (3D) printing apparatus includes a housing, a plurality of nozzle assemblies each including a nozzle portion and a heater, a moving grip portion capable of being separated from or fastened to any one of the plurality of nozzle assemblies, a driving portion formed in the housing and configured to move the moving grip portion in three axial directions, and a standby frame on which at least one of the plurality of nozzle assemblies is mounted. Here, each of the plurality of nozzle assemblies includes a first coupling portion. The moving grip portion includes a second coupling portion capable of being magnetically coupled with the first coupling portion. Any one of the first coupling portion and the second coupling portion is formed of a magnetic body, and the other of the first coupling portion and the second coupling portion is formed of an electromagnet.

### CROSS-REFERENCE TO RELATED APPLICATION

This application claims priority to and the benefit of Korean Patent Application No. 10-2019-0158275, filed on Dec. 2, 2019, the disclosure of which is incorporated herein by reference in its entirety.

### BACKGROUND

### 1. Field

Embodiments of the present disclosure relate to a three-dimensional (3D) printing apparatus.

### 2. Discussion of Related Art

A three-dimensional (3D) printing apparatus is an apparatus configured to manufacture a preset 3D shape according to a 3D drawing. Here, such 3D printing apparatuses may be classified, according to materials, into a frequency division multiplex (FDM) method, a poly jet method, and a selective laser sintering (SLS) method. Particularly, the FDM method uses a solid material, the poly jet method uses a liquid material, and the SLS method uses a powder material.

Among them, in the FDM method, a plastic material which is a solid may be melted and discharged onto a printing bed so as to perform a printing operation, and the melted plastic material may be gradually stacked on a molding plate so as to manufacture a 3D shape.

Meanwhile, in order to output a 3D product formed of a composite material having different colors and properties, it is necessary to alternately use a plurality of types of filaments having different colors and properties. However, in a conventional 3D printing apparatus, there are problems that a plurality of types of filaments are sequentially and alternately inserted into a single nozzle and heater to be used for a printing operation and materials having different properties are mixed with each other during a 3D printing operation.

Also, since the plurality of types of filaments have different melting temperatures, heating a heater according to each material property so as to use the heater for the 3D printing operation takes a long time, and finally, this causes degradation of 3D printing output quality is caused.

### SUMMARY

Embodiments of the present disclosure are intended to provide a three-dimensional (3D) printing apparatus capable of performing a 3D printing operation using any one selected from a plurality of nozzle assemblies and capable of performing replacement with any other of the plurality of nozzle assemblies.

Embodiments of the present disclosure are also intended to provide a 3D printing apparatus capable of alternately using a variety of materials having different properties according to a user's needs.

Embodiments of the present disclosure are also intended to provide a 3D printing apparatus capable of easily controlling coupling and separation of a nozzle assembly.

Embodiments of the present disclosure are also intended to provide a 3D printing apparatus capable of reducing vibrations and a load on a driving portion during separation of a nozzle assembly.

Embodiments of the present disclosure are also intended to provide a 3D printing apparatus capable of preventing heat from being generated at a coupled part while coupling of a nozzle assembly is maintained.

According to an aspect of the present disclosure, there is a 3D printing apparatus including a housing, a plurality of nozzle assemblies each including a nozzle portion and a heater, a moving grip portion separable from or fastenable to any one of the plurality of nozzle assemblies, a driving portion formed in the housing and configured to move the moving grip portion in at least two axial directions, and a standby frame on which at least one of the plurality of nozzle assemblies is mounted. Here, each of the plurality of nozzle assemblies includes a first coupling portion. The moving grip portion includes a second coupling portion that allows the first coupling portion to be magnetically coupled therewith. Any one of the first coupling portion and the second coupling portion is formed of a magnetic body. Also, the other of the first coupling portion and the second coupling portion is formed of an electromagnet.

The moving grip portion may include at least two guide pins formed to protrude toward one side. Here, each of the plurality of nozzle assemblies may include at least two guide grooves into which the guide pins are insertable. Also, the at least two guide pins may be inserted into the at least two guide grooves such that the moving grip portion and the any one of nozzle assemblies may be located to come into contact with each other in a preset structure.

The moving grip portion may include a fastening portion rotated by a preset angle. Here, each of the plurality of nozzle assemblies may include a fastened groove into which the fastening portion is inserted. Also, any one of the plurality of nozzle assemblies may be pressed against and fastened to the moving grip portion as the fastening portion is rotated while being inserted into the fastened groove.

Each of the plurality of nozzle assemblies may include an attached block including the fastened groove formed therein. Here, the fastened groove may be formed to extend to a certain length. Also, the fastening portion may approach from one side of the attached block, be inserted into and pass through the fastened groove, and be rotated while being inserted into the fastened groove so as to be pressed against the other surface of the attached block.

The standby frame may include a plurality of mounting portions on which the plurality of nozzle assemblies are correspondingly mounted. Here, each of the plurality of mounting portions may include a mount-support portion formed to protrude toward an inside of the housing and at least two mounting pins located to be parallel to the ground and vertically spaced apart from each other. The at least two mounting pins may be formed to protrude from the mount-support portion in a direction perpendicular to a protruding direction of the mount-support portion. Each of the plurality of nozzle assemblies may include at least two mounting holes. Also, at least one of the plurality of nozzle assemblies may be mounted on the standby frame while the at least two mounting pins are correspondingly inserted into the at least two mounting holes.

The 3D printing apparatus may further include a control portion connected to the driving portion and the moving grip portion and a bed portion on which a product having a preset shape is formed by the nozzle assembly fastened to the moving grip portion. Here, the control portion may sense a distance between the bed portion and the nozzle assembly fastened to the moving grip portion. Also, the nozzle assembly may form the product having the preset shape to compensate for a height error on the basis of the distance.

The housing may include four side members located to be perpendicular to the ground. The 3D printing apparatus may include at least two partition members disposed to be spaced at a certain interval apart from at least two of the side members. Here, a partitioned space may be formed between the at least two partition members and the at least two side members. Also, at least a part of the driving portion may be located in the partitioned space.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view of a three-dimensional (3D) printing apparatus according to one embodiment of the present disclosure;

FIG. 2 is a view illustrating an inner structure of a housing of the 3D printing apparatus according to one embodiment of the present disclosure;

FIG. 3 is an enlarged view illustrating part A of FIG. 2;

FIG. 4 is an enlarged view illustrating part B of FIG. 2;

FIG. 5 is a view illustrating a standby frame structure of the 3D printing apparatus according to one embodiment of the present disclosure;

FIG. 6 is a first exploded perspective view illustrating a moving grip portion and a nozzle assembly of the 3D printing apparatus according to one embodiment of the present disclosure; and

FIG. 7 is a second exploded perspective view illustrating the moving grip portion and the nozzle assembly of the 3D printing apparatus according to one embodiment of the present disclosure.

### DETAILED DESCRIPTION OF EXEMPLARY EMBODIMENTS

Hereinafter, detailed embodiments of the present disclosure will be described with reference to the accompanying drawings. However, these are merely examples and the present disclosure is not limited thereto.

In describing embodiments of the present disclosure, when it is determined that a detailed description of known techniques associated with the present disclosure would unnecessarily obscure the subject matter of the present disclosure, the detailed description thereof will be omitted. Also, terms used herein are defined in consideration of the functions of the present disclosure and may be changed depending on a user, the intent of an operator, or a custom. Accordingly, the terms should be defined based on the following overall description of this specification.

The technical concept of the present disclosure will be determined by the claims, and the following embodiments are merely means for efficiently describing the technical concept of the present disclosure to one of ordinary skill in the art.

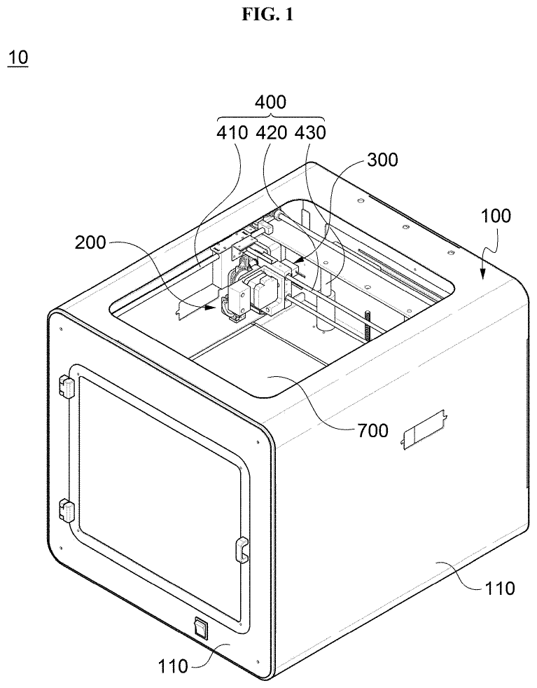

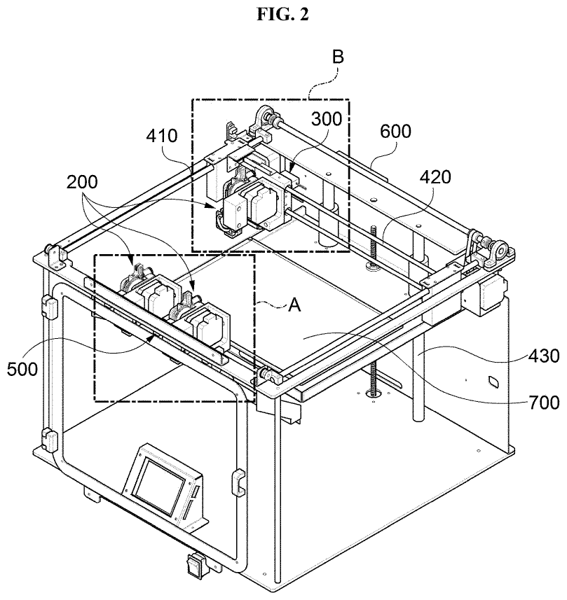

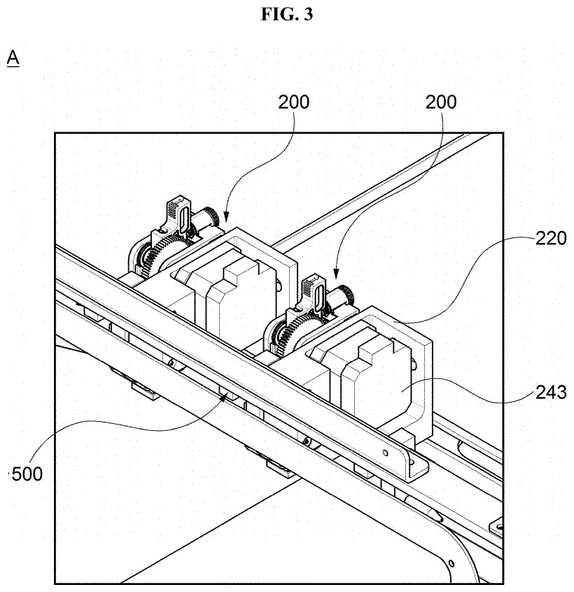

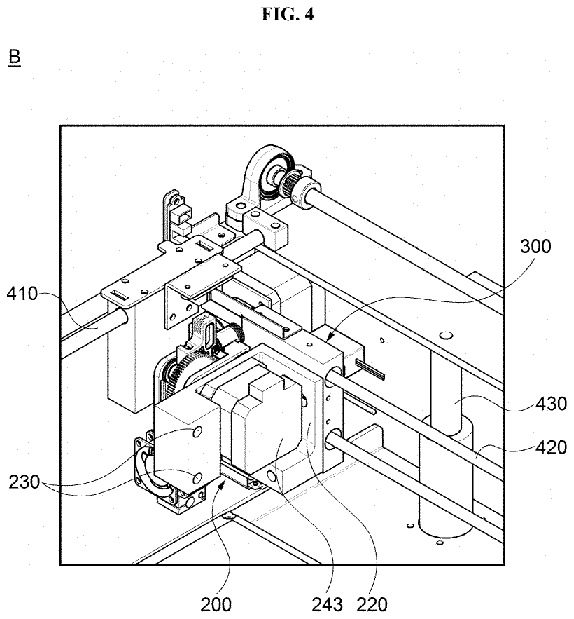

FIG. 1 is a view of a three-dimensional (3D) printing apparatus 10 according to one embodiment of the present disclosure, FIG. 2 is a view illustrating an inner structure of a housing 100 of the 3D printing apparatus 10 according to one embodiment of the present disclosure, FIG. 3 is an enlarged view illustrating part A of FIG. 2, and FIG. 4 is an enlarged view illustrating part B of FIG. 2.

Referring to FIGS. 1 to 4, the 3D printing apparatus 10 according to one embodiment of the present disclosure may include the housing 100, a plurality of nozzle assemblies 200, a moving grip portion 300, a driving portion 400, and a standby frame 500. Here, each of the plurality of nozzle assemblies 200 may include a nozzle portion 241, a heater 242, and an extrusion motor 243 configured to extrude a material toward the nozzle portion 241.

Also, the plurality of nozzle assemblies 200 may be connected to materials having different properties and fastened to the moving grip portion 300 to be used for 3D printing operation. Here, a material connected to each of the plurality of nozzle assemblies 200 may be moved toward the heater 242 by the extrusion motor 243, and a material melted by the heater 242 may be discharged outward through the nozzle portion 241.

Meanwhile, the above-described moving grip portion 300 may be separated from or fastened to any one of the plurality of nozzle assemblies 200, and the driving portion 400 may be formed in the housing 100 and move the moving grip portion 300 in at least two axial directions. Also, at least one of the plurality of nozzle assemblies 200 may be mounted and located in the standby frame 500. That is, the 3D printing apparatus 10 according to one embodiment of the present disclosure may perform the 3D printing operation while alternately selecting a plurality of materials.

In detail, the plurality of nozzle assemblies 200 may be located in a state of being mounted on the standby frame 500, and the moving grip portion 300 may be moved by the driving portion 400 and fastened to any one of the plurality of nozzle assemblies 200. In this case, other parts excluding the any one of the plurality of nozzle assemblies 200 may be located on the standby frame 500. Also, the moving grip portion 300 fastened to the any one of nozzle assemblies 200 may be moved by the driving portion 400 in at least two axial directions, and the 3D printing operation may be performed by moving the moving grip portion 300 and operating the any one of the nozzle assemblies 200.

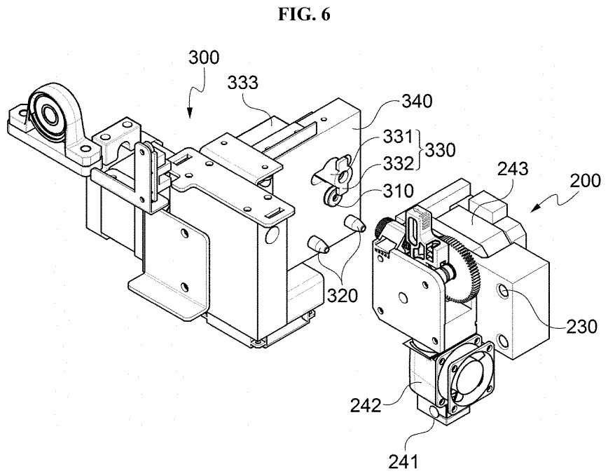

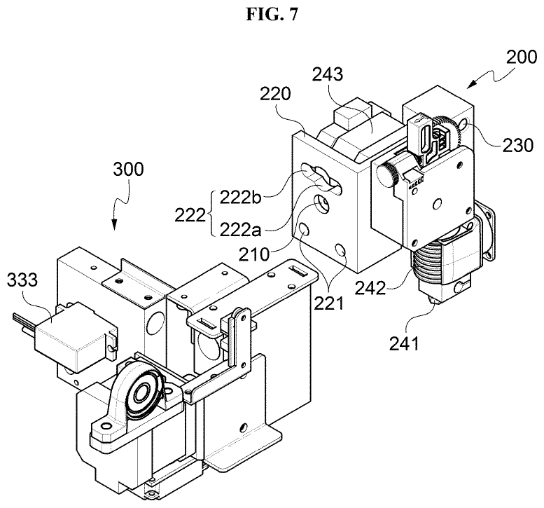

In more detail, each of the plurality of nozzle assemblies 200 may include a first coupling portion 210 (refer to FIG. 7), and the moving grip portion 300 may include a second coupling portion 310 (refer to FIG. 6) capable of being magnetically coupled with the first coupling portion 210. Here, any one of the first coupling portion 210 and the second coupling portion 310 may be formed of a magnetic material, and the other of the first coupling portion 210 and the second coupling portion 310 may be formed of an electromagnet. Preferably, the second coupling portion 310 included in the moving grip portion 300 may be formed of an electromagnet, and the first coupling portion 210 included in the nozzle assembly 200 may be formed of a magnetic material.

That is, the second coupling portion 310 of the moving grip portion 300 may determine whether to generate a magnetic force according to whether a current is applied. When the magnetic force is generated in the second coupling portion 310, the first coupling portion 210 adjacent thereto may be located to come into contact with the second coupling portion 310 due to the magnetic force.

Meanwhile, the 3D printing apparatus 10 according to one embodiment of the present disclosure may further include a control portion 600 connected to the driving portion 400 and the moving grip portion 300 and further include a bed portion 700 on which a product formed by the nozzle assembly 200 fastened to the moving grip portion 300 to have a preset shape is located. Also, the driving portion 400 may include a first shaft 410 configured to guide movement of the moving grip portion 300 in an X-axis direction, a second shaft 420 configured to guide movement of the moving grip portion 300 in a Y-axis direction, and a third shaft 430 configured to guide movement of the bed portion 700 in a Z-axis direction.

In addition, the driving portion 400 may include a plurality of motor members configured to move the moving grip portion 300 in the X-axis and Y-axis directions and to move the bed portion 700 in the Z-axis direction. Here, X-axis and Y-axis may be axial directions which are perpendicular to each other in a plane parallel to the ground, and Z-axis may refer to a height direction perpendicular to the ground. Also, the driving portion 400 may control positions of the moving grip portion 300 on the X-axis and Y-axis by driving the moving grip portion 300 in at least one side of the X-axis and Y-axis, and the driving portion 400 may control a height position of the bed portion 700 in the Z-axis direction.

Meanwhile, movement of the moving grip portion 300 is not limited thereto, and the driving portion 400 may control the moving grip portion 300 to move in three axial directions such as the X-axis, Y-axis, and Z-axis directions. In addition, the nozzle assembly 200 fastened to the moving grip portion 300 may form a product having a preset shape on the basis of height information preset in the control portion 600.

Meanwhile, the control portion 600 may sense a distance between the bed portion 700 and the any one of the plurality of nozzle assemblies 200 fastened to the moving grip portion 300. Also, the any one of the plurality of nozzle assemblies 200 may form the product having the preset shape to compensate for a height error on the basis of the sensed distance.

In detail, when the height information between the nozzle assembly 200 and the bed portion 700, which is preset in the control portion 600, differs from the actually sensed distance between the nozzle assembly 200 and the bed portion 700 during the 3D printing operation using the any one of the plurality of nozzle assemblies 200 fastened to the moving grip portion 300, the control portion 600 may determine that a height error occurs between the nozzle assembly 200 and the bed portion 700.

That is, a manufacturing error may occur such as being manufactured in a shape different from the preset product shape due to the height error during the 3D printing operation using the nozzle assembly 200. Here, the control portion 600 may control an extrusion speed and the like of the any one nozzle assembly 200 to compensate for the manufacturing error caused by the height error, and the product formed on the bed portion 700 may be formed to have an initially preset shape.

Meanwhile, the housing 100 may include four side members 110 located to be perpendicular to the ground, and the 3D printing apparatus 10 according to one embodiment of the present disclosure may further include at least two partition members (not shown) disposed to be spaced at a certain distance from at least two side members 110. Here, a partitioned space may be formed between the at least two partition members and the at least two side members 110, and at least a part of the driving portion 400 may be located in the partitioned space. Also, between the at least two partition members, the bed portion 700 may be located and a manufacturing space in which the 3D printing operation is performed may be formed.

Also, a heating portion (not shown) may be located in the manufacturing space and may maintain a temperature in the manufacturing space at a preset temperature or higher. Preferably, the heating portion may heat and maintain the temperature in the manufacturing space at a temperature in a range from 200 to 300° C.

Consequently, even when engineering plastic is used as a 3D printing material, the manufacturing space may be maintained at a high temperature and an adhesive property between materials having different properties may be increased. In addition, since a product formed on the bed portion 700 during a printing operation using the nozzle assembly 200 is built, it is possible to prevent an end part (edge part) of a contact surface between the product and the bed portion 700 from rolling up.

Meanwhile, the plurality of motor members of the driving portion 400 may be located in the partitioned space. That is, the plurality of motor members configured to drive at least one of the moving grip portion 300 and the bed portion 700 may be located in the partitioned space separated from the manufacturing space and may be separated from a high-temperature environment inside the manufacturing space. Consequently, it is possible to prevent the plurality of motor members from being damaged or degraded in performance due to the high-temperature environment caused by the heating portion.

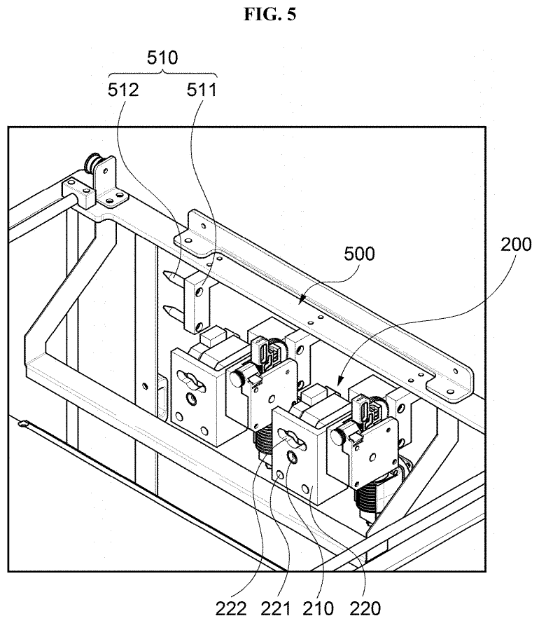

FIG. 5 is a view illustrating a structure of the standby frame 500 of the 3D printing apparatus according to one embodiment of the present disclosure.

Referring to FIG. 5, the above-described standby frame 500 may include a plurality of mounting portions 510 on which the plurality of nozzle assemblies 200 are correspondingly mounted. Here, the plurality of mounting portions 510 may be formed to protrude from any one sidewall member toward the inside of the housing 100. Also, each of the plurality of mounting portions 510 includes at least two mounting pins 512 located parallel to the ground and a mount-support portion 511 protruding toward the inside of the housing 100 and spaced vertically from each other.

In detail, the at least two mounting pints 512 may be formed to protrude from the mount-support portion 511 in a direction perpendicular to a protruding direction of the mount-support portion 511, and each of the plurality of nozzle assemblies 200 may include at least two mounting holes 230. Here, at least one of the plurality of nozzle assemblies 200 may be mounted on the standby frame 500 according to the at least two mounting pins 512 being correspondingly inserted into at least two mounting holes 230 in each nozzle assembly 200.

Here, a direction in which the at least two mounting pins 512 are inserted into the at least two mounting holes 230 may perpendicular to an insertion direction of a fastening portion 330 (refer to FIG. 6) and a fastened groove 222 (refer to FIG. 7) which will be described below. That is, it is possible to prevent the at least two mounting holes 230 from being pushed out from the at least two mounting pins 512 due to an external force generated during a process of fastening or separation between the fastening portion 330 and the fastened groove 222 during a process of separating or fastening the moving grip portion 300 and the nozzle assembly 200 standing by on the any one mounting portion 510.

In addition, materials having mutually different properties may be connected to the plurality of nozzle assemblies 200 disposed on the plurality of mounting portions 510, and information on the materials connected to the nozzle assemblies 200 located on the plurality of mounting portions 510 may be previously input to the control portion 600. That is, in the control portion 600, it has been input which material with a property is connected to which one of the plurality of nozzle assemblies 200 disposed on the plurality of mounting portions 510. Accordingly, the control portion 600 may fasten the nozzle assembly 200 connected to any one material to the moving grip portion 300 only by recognizing a position of each of the plurality of mounting portions 510 during the 3D printing operation and may use any one selected material in the 3D printing operation.

Additionally, the control portion 600 may control a heating temperature of a heater 242 in the fastened nozzle assembly 200 corresponding to a property of the any one selected material. Also, it is possible to control a heating temperature of the heating portion according to the property of the any one selected material. Consequently, the control portion 600 may easily control the heating temperature of the heater 2422 and the heating temperature of the heating portion to be appropriate for the material property simultaneously while at least one of the plurality of nozzle assemblies 200 is alternately used.

FIG. 6 is a first exploded perspective view illustrating the moving grip portion 300 and the nozzle assembly 200 of the 3D printing apparatus 10 according to one embodiment of the present disclosure, and FIG. 7 is a second exploded perspective view illustrating the moving grip portion 300 and the nozzle assembly 200 of the 3D printing apparatus 10 according to one embodiment of the present disclosure.

Referring to FIGS. 6 and 7, the moving grip portion 300 may include a moving block 340 and at least two guide pins 320 formed to protrude from the moving block 340 toward one side, and each of the plurality of nozzle assemblies 200 may include at least two guide grooves 221 into which the guide pins 320 are insertable. Here, the moving block 340 may be formed to face an attached block 220 of any one of nozzle assembly 200, which will be described below, and the at least two guide pins 320 are inserted into the at least two guide grooves 221 such that the moving grip portion 300 and any one nozzle assembly 200 may be contact-located in a preset structure. That is, the at least two guide pins 320 and the at least two guide grooves 221 may guide a fastening position between the moving grip portion 300 and the nozzle assembly 200.

Also, the moving grip portion 300 may include the fastening portion 330 rotated by a preset angle, and each of the plurality of nozzle assemblies 200 may include the fastened groove 222 into which the fastening portion 330 is inserted. Here, any one of the plurality of nozzle assemblies 200 may be press-fastened to the moving grip portion 300 as the fastening portion 330 is rotated while being inserted into the fastened groove 222.

That is, one of the nozzle assemblies 200 to be used in a printing operation may be stably fastened to the moving grip portion 300 as the fastening portion 330 is rotated while being inserted into the fastened groove 222.

In detail, each of the plurality of nozzle assemblies 200 may include the attached block 220 including the fastened groove 222 formed therein, and the fastened groove 222 may be formed to extend to a certain length. Here, as the moving grip portion 300 is moved, the fastening portion 330 may approach from one side of the attached block 220, be inserted into and pass through the fastened groove 222, and rotated while being inserted into the fastened groove 222 so as to be pressed against the other surface of the attached block 220.

That is, the fastening portion 330 may press-fasten the attached block 220, and the nozzle assembly 200 may be located to be fastened to the moving grip portion 300 even when a current is not applied to the second coupling portion 310 (that is, an electromagnet is not operated). Consequently, to attach and fasten the moving grip portion 300 to the nozzle assembly 200, it is unnecessary to continuously apply currents to the second coupling portion 310 and it is possible to alleviate heating and the like caused by continuously applying currents.

In more detail, the moving grip portion 300 may further include a rotation operation portion 333 configured to rotate the fastening portion 330. Also, the fastening portion 330 may include a rotation body 331 formed to have a cylindrical shape with a certain length and extending protrusions 332 formed to protrude from both sides of an end of the rotation body 331 in a radial direction. Here, the rotation body 331 may be rotated while being connected to the rotation operation portion 333, and the extending protrusions 332 may be rotated together with the rotation body 331. Meanwhile, the fastened groove 222 may include a central groove 222a formed to have a shape corresponding to the rotation body 331 and through which the rotation body 331 passes, and include extending grooves 222b formed to extend from both sides of the central groove 222a in a radial direction and through which extending protrusions 332 pass.

Also, the extending protrusions 332 may be formed to have a thickness smaller than a length of the rotation body 331. Consequently, when the fastening portion 330 is inserted into one side of the attached block 220 and is located in a state of passing through the other surface of the attached block 220, the extending protrusions 332 may be located outside the other surface of the attached block 220. Here, when the fastening portion 330 is rotated by an operation of the rotation operation portion 333, the extending protrusions 332 may be pressed against the other surface of the attached block 220.

In addition, a tapered surface may be formed on an outer circumference of the fastened groove 222 of the other side of the attached block 220 and may be inclined along a rotational direction of the fastening portion 330. In more detail, the tapered surface may be formed to have a thickness gradually increasing from one surface of the attached block 220 from a position where the extending protrusions 332 initially come into contact to a position where the extending protrusions 332 are rotated by a preset angle when the fastening portion 330 rotates.

Accordingly, when the fastening portion 330 is rotated while being inserted into and passing through the fastened groove 222, the extending protrusions 332 may be rotated by as much as the preset angle and be rotated while being pressed against the tapered surface such that the attached block 220 may be press-fastened to the moving grip portion 300.

Meanwhile, the first coupling portion 210 may be located on the attached block 220, and the first coupling portion 210 may be located to be recessed from one surface of the attached block 220 at a certain depth. Also, the second coupling portion 310 may be located to protrude from the moving block 340 in the same direction as that of the guide pin 320. That is, when the at least two guide pins 320 are inserted into the at least two guide grooves 221, the fastening portion 330 may be correspondingly inserted into the fastened groove 222 and the second coupling portion 310 may be inserted into and come into contact with a recession position of the first coupling portion 210.

Accordingly, since the moving grip portion 300 and the nozzle assembly 200 are inserted and fastened at least four positions, contact with mutual fastening positions may be easily induced. Also, since the insertion structure of the at least two guide pins 320 and the at least two guide grooves 221 is continuously maintained in addition to fastening between the fastening portion 330 and the fastened groove 222, it is possible to prevent an error in the printing operation caused by occurrence of vibrations, a gap between the moving grip portion 300 and the nozzle assembly 200, or the like during the 3D printing operation.

According to embodiments of the present disclosure, it is possible to perform a 3D printing operation using any one selected from a plurality of nozzle assemblies and to perform replacement with any other of the plurality of nozzle assemblies.

Also, according to embodiments of the present disclosure, it is possible to alternately use a variety of materials having different properties according to a user's needs.

Also, according to embodiments of the present disclosure, it is possible to easily control coupling and separation of a nozzle assembly.

Also, according to embodiments of the present disclosure, it is possible to reduce vibrations and a load on a driving portion during separation of a nozzle assembly.

Also, according to embodiments of the present disclosure, it is possible to prevent heat from being generated at a coupled part while coupling of a nozzle assembly is maintained.

Although example embodiments of the present disclosure have been described in detail, it should be understood by those skilled in the art that various changes may be made without departing from the spirit or scope of the present disclosure. Therefore, the scope of the present disclosure is to be determined by the following claims and their equivalents, and is not restricted or limited by the foregoing detailed description.

What is claimed is:

1. A three-dimensional (3D) printing apparatus comprising:
a housing;
a plurality of nozzle assemblies each comprising a nozzle portion and a heater;
a moving grip portion separable from or fastenable to any one of the plurality of nozzle assemblies;
a driving portion formed in the housing and configured to move the moving grip portion in at least two axial directions; and
a standby frame on which at least one of the plurality of nozzle assemblies is mounted,
wherein each of the plurality of nozzle assemblies comprises a first coupling portion;
the moving grip portion comprises a second coupling portion that allows the first coupling portion to be magnetically coupled therewith;
any one of the first coupling portion and the second coupling portion is formed of a magnetic body; and
the other of the first coupling portion and the second coupling portion is formed of an electromagnet.

2. The 3D printing apparatus of claim 1, wherein the moving grip portion comprises at least two guide pins formed to protrude toward one side;
each of the plurality of nozzle assemblies comprises at least two guide grooves into which the guide pins are insertable; and
the at least two guide pins are inserted into the at least two guide grooves such that the moving grip portion and the any one of nozzle assemblies are located to come into contact with each other in a preset structure.

3. The 3D printing apparatus of claim 1, wherein the moving grip portion comprises a fastening portion rotated by a preset angle;
each of the plurality of nozzle assemblies comprises a fastened groove into which the fastening portion is inserted; and
any one of the plurality of nozzle assemblies is pressed against and fastened to the moving grip portion as the fastening portion is rotated in a state of being inserted into the fastened groove.

4. The 3D printing apparatus of claim 3, wherein each of the plurality of nozzle assemblies comprises an attached block including the fastened groove formed therein;
the fastened groove is formed to extend to a certain length; and
the fastening portion approaches from one side of the attached block, is inserted into and passes through the fastened groove, and is rotated in a state of being inserted into the fastened groove so as to be pressed against the other surface of the attached block.

5. The 3D printing apparatus of claim 1, wherein the standby frame comprises a plurality of mounting portions on which the plurality of nozzle assemblies are correspondingly mounted,
wherein each of the plurality of mounting portions comprises:
a mount-support portion formed to protrude toward an inside of the housing; and
at least two mounting pins located to be parallel to the ground and vertically spaced apart from each other,
wherein the at least two mounting pins are formed to protrude from the mount-support portion in a direction perpendicular to a protruding direction of the mount-support portion;
wherein each of the plurality of nozzle assemblies comprises at least two mounting holes; and
at least one of the plurality of nozzle assemblies is mounted on the standby frame in a state in which the at least two mounting pins are correspondingly inserted into the at least two mounting holes.

6. The 3D printing apparatus of claim 1, further comprising:
a control portion connected to the driving portion and the moving grip portion; and
a bed portion on which a product having a preset shape is formed by the nozzle assembly fastened to the moving grip portion,
wherein the control portion senses a distance between the bed portion and the nozzle assembly fastened to the moving grip portion; and
the nozzle assembly forms the product having the preset shape to compensate for a height error on the basis of the distance.

7. The 3D printing apparatus of claim 1, wherein the housing comprises four side members located to be perpendicular to the ground;
the 3D printing apparatus comprising at least two partition members disposed to be spaced at a certain interval apart from at least two of the side members;
a partitioned space is formed between the at least two partition members and the at least two side members; and
at least a part of the driving portion is located in the partitioned space.
